(19) United States
(12) Patent Application Publication
(10) Pub. No.: US 2007/0289178 A1
(43) Pub. Date: Dec. 20, 2007

(54) Swinging decoration of wind exit

(76) Inventors: Chien-Tsai Lee, Hsing-Juang City (TW); Rung-Chuen Lee, Hsing-Juang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/455,770

(22) Filed: Jun. 20, 2006

(51) Int. Cl. G09F 19/08

(52) U.S. Cl. 40/412

(57) ABSTRACT

A swinging decoration of wind exit, includes a fan unit including a housing formed with an axial wind-guiding passage. A fan being pivotally mounted in the wind-guiding passage. A swinging member pivotally connected to an outer circumference of the housing. A driving mechanism installed between a rotary shaft of the fan and the swinging member and drivable by the fan to drive the swinging member to reciprocally swing up and down. The swinging member has a projecting fixing plate formed with fixing pins. The fixing pins can be inserted in corresponding pinholes of a pressboard. A decorative plate is tightly replaceably clamped and sandwiched between the fixing plate and the pressboard. The swinging decoration can present various configurations such as flying butterfly, bee, bird, etc.

### BACKGROUND OF THE INVENTION

1. Field of the Invention

The present invention is related to a swinging decoration of wind exit, and more particularly a swinging decoration in which the decorative plates are easily replaceable to simulate various configurations such as flying butterfly, bee, bird, etc.

2. Description of the Prior Art

A conventional wind exit of an indoor air-conditioner or a car air-conditioner has multiple wind-guiding slats. When the air-conditioner is activated, the wind blows out through the wind-guiding slats. Such wind-guiding slats have monotonous appearance. Therefore, various wind exit decorations have been developed for beautifying the wind exit of the air-conditioner. For example, there is a wind exit decoration with a configuration of a helicopter. Such decoration can clip the wind exit of an air-conditioner. When the air-conditioner is activated, the wind blows out to drive the propeller of helicopter so as to simulate a flying helicopter. However, such decoration cannot simulate other pattern of movement such as swinging. For example, a natural insect cannot be simulated.

It is therefore tried by the applicant to provide a swinging decoration of wind exit to simulate a flying insect or other animal in natural world.

### SUMMARY OF THE INVENTION

It is therefore a primary object of the present invention to provide a swinging decoration of wind exit, including: a fan unit including a housing formed with an axial wind-guiding passage, a fan being pivotally mounted in the wind-guiding passage; a swinging member pivotally connected to an outer circumference of the housing; and a driving mechanism installed between a rotary shaft of the fan and the swinging member and drivable by the fan to drive the swinging member to reciprocally swing up and down. The swinging member has a projecting fixing plate formed with fixing pins. The fixing pins can be inserted in corresponding pinholes of a pressboard. A decorative plate is tightly replaceably clamped and sandwiched between the fixing plate and the pressboard. The swinging decoration can present various configurations such as flying butterfly, bee, bird, etc. In addition, a chamber is formed on an outgoing side of the housing of the fan unit of the swinging decoration. A bottom of the chamber is formed with multiple vents axially communicating with the wind-guiding passage in alignment with the fan. An opening of the chamber is formed with a wind-guiding slope. The aromatic particles of the aromatic placed in the chamber can be easily spread around.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention, also showing a decoration main body;

FIG. 3 is a perspective view according to FIG. 2, in which the decoration main body is fixed on the chucking seat of the present invention;

FIG. 4 is a partially sectional view taken along line 4-4 of FIG. 3;

FIG. 5 is a right side view according to FIG. 3;

FIG. 6 is a view according to FIG. 5, showing a position relationship between the driving mechanism and the swinging member; and

FIG. 7 is a view according to FIG. 6, showing another position relationship between the driving mechanism and the swinging member, in which the decorative plates of the swinging members are swung upward.

### DETAILED DESCRIPTION OF THE PREFERRED EMBODIMENTS

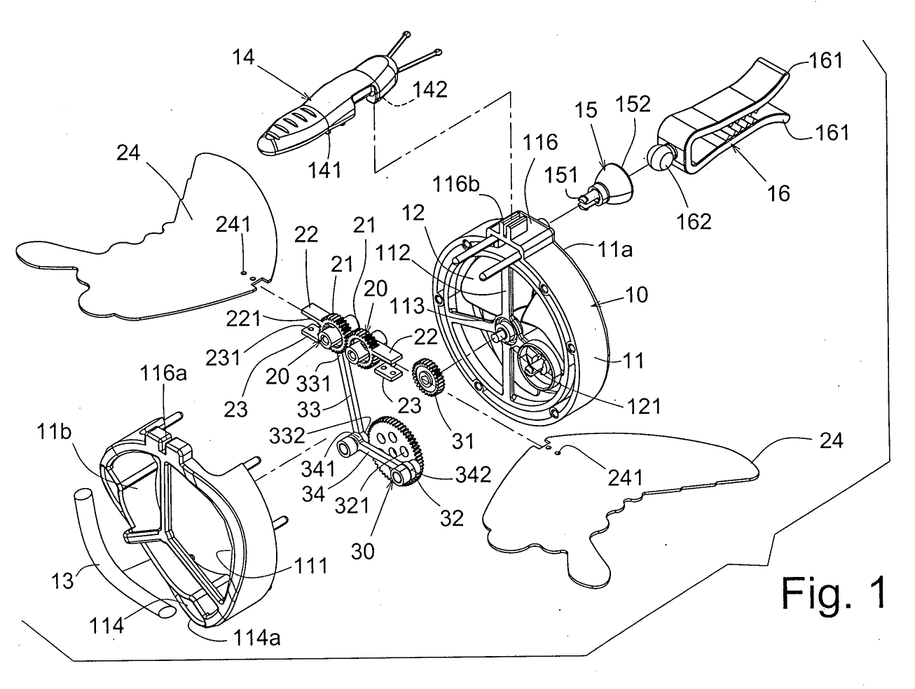

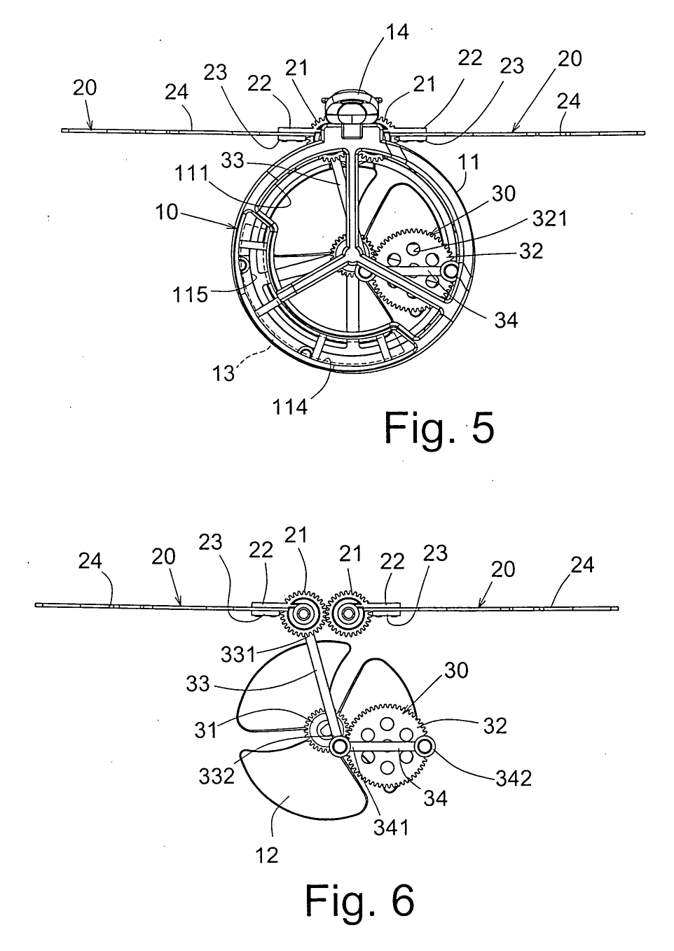

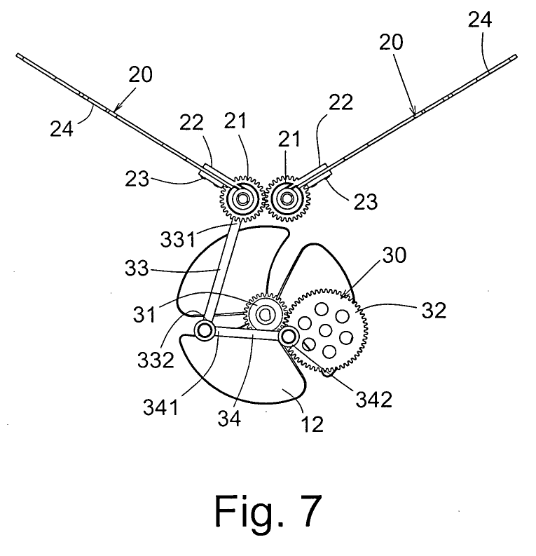

Please refer to FIGS. 1 to 7. The swinging decoration of wind exit of the present invention includes a fan unit 10, a swinging member 20 and a driving mechanism 30. The fan unit 10 includes a housing 11 formed with an axial wind-guiding passage 111. A fan 12 is pivotally mounted in the wind-guiding passage 111. The swinging member 20 is pivotally connected to an outer circumference of the housing 11. The driving mechanism 30 is installed between a rotary shaft 121 of the fan 12 and the swinging member 20 and drivable by the fan 12 to drive the swinging member 20 to reciprocally swing up and down. The swinging member 20 has a projecting fixing plate 22 formed with fixing pins 221. The fixing pins 221 can be inserted in corresponding pinholes 231 of a pressboard 23, whereby a decorative plate 24 can be sandwiched between the fixing plate 22 and the pressboard 23. The decorative plate 24 is replaceable. Therefore, the swinging decoration of the present invention can present various configurations such as flying butterfly, bee, bird, etc.

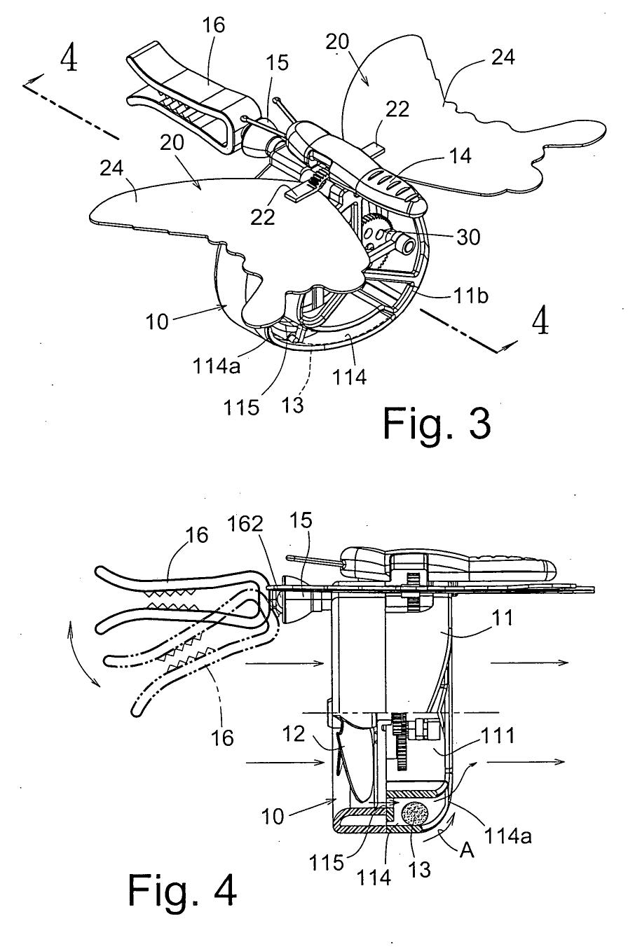

Referring to FIGS. 1, 2 and 3, the fan unit 10 includes a housing 11 includes a housing 11 formed with an axial wind-guiding passage 111. Ribs 112 radially extend from a circumference of the wind-guiding passage 111 toward a center of the housing 11 and connect with each other at the center of the housing 11, where the ribs 112 are formed with a shaft hole 113 in which the rotary shaft 121 of the fan 12 is rotatably fitted as shown in FIGS. 3, 4 and 5. A chamber 114 is formed on an outgoing side 11b of the housing 11, in which an aromatic 13 can be placed. The bottom of the chamber 114 is formed with multiple vents 115 axially communicating with the wind-guiding passage 111 in alignment with the fan 12. When the wind blows from an incoming side 11a of the housing 11 through the fan 12 and the vents 115, the aromatic particles are entrained by the air and blown out.

Referring to FIG. 4, an opening of the chamber 114 of the housing 11 is formed with a wind-guiding slope 114a. When the wind blows out from the wind-guiding passage 111 of the housing 11, the pressure of the outgoing side 11b of the housing 11 drops to suck in the external air A. The sucked in air A blows along the wind-guiding slope 114a toward the aromatic 13 to entrain the aromatic particles into the airflow blown out from the wind-guiding passage 111. Therefore, the aromatic particles can be blown to remote place and spread around.

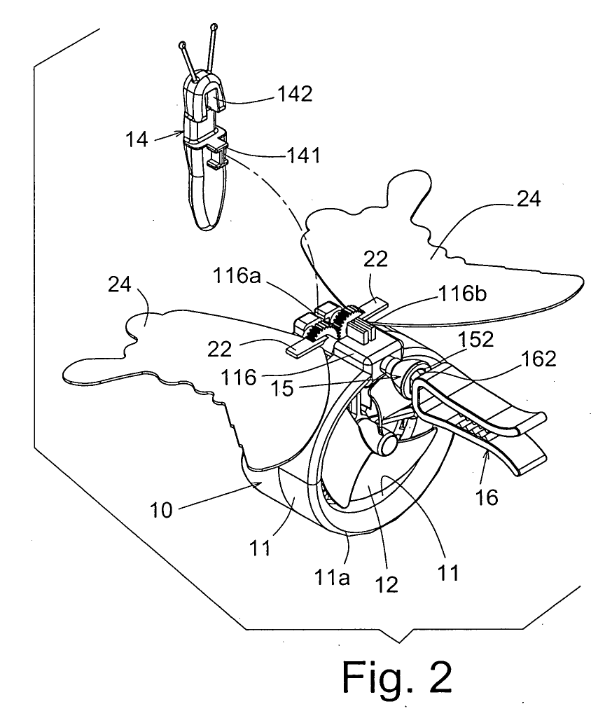

Referring to FIGS. 1 and 2, a chucking seat 116 is arranged on the outer circumference of the housing 11 of the fan unit 10. A decoration main body 14 is chucked on the chucking seat 116. The decoration main body 14 can have a configuration of a butterfly, a bee, a bird, etc. This is not limited. The bottom of the decoration main body 14 has an I-shaped tenon 141, while the chucking seat 116 has a corresponding mortise in which the tenon 141 can be inserted. The tenon 141 is held by two opposite walls of the mortise 116a to prevent the decoration main body 14 from transversely and longitudinally sliding. In addition, the bottom of the decoration main body 14 is formed with multiple insertion slots 142. The chucking seat 116 further has insertion slats 116b corresponding to the insertion slots 142. The insertion slats 116b can be inserted in the insertion slots 142 to firmly locate the decoration main body 14 on the chucking seat 116. In addition, the decoration main body 14 can be replaced as necessary.

Referring to FIGS. 1 and 4, the swinging decoration of the present invention further includes a connecting seat 15 having an insertion bolt 151 at one end for latching with the incoming side 11a of the housing 11. A resilient clip 16 is connected with the other end of the connecting seat 15 for tightly clipping a stationary article such as the wind exit of the air conditioner (not shown). The resilient clip 16 has a pair of resilient clip arms 161 extending from a first side of the resilient clip 16 for clipping the stationary article. A second side of the resilient clip 16 has a ball joint 162 pivotally fitted in a ball cavity 152 of the connecting seat 15, whereby the connecting seat 15 can be universally adjusted to vary the angular position of the fan unit 10. For example, the fan 12 of the fan unit 10 can be right aligned with the wind exit, whereby the wind can easily drive the fan 12 to drive the swinging member 20.

Referring to FIGS. 1, 5, 6 and 7, the swinging decoration of the present invention includes a pair of swinging members 20 each having a gear 21 pivotally disposed on the housing 11 of the fan unit 10. The gears 21 of the swinging members 20 are engaged with each other. One of the gears 21 is drivable by the driving mechanism 30. The fixing plate 22 projects from an outer circumference of the gear 21 and has the fixing pins 221. The decorative plate 24 is sandwiched between the fixing plate 22 and the pressboard 23.

The decorative plate 24 is formed with through holes 241 through which the fixing pins.221 of the fixing plate 22 are fitted to prevent the decorative plate 24 from dropping when the swinging member 20 swings.

The driving mechanism 30 of the swinging decoration of the present invention includes a driving gear 31 coupled with the rotary shaft 121 of the fan 12 and a driven gear 32 pivotally connected with the fan unit 10 and always drivingly engaged with the driving gear 31. The driven gear 32 is arranged in the wind-guiding passage 111 and aligned therewith. The driven gear 32 is formed with multiple vents 321. The driving mechanism 30 further includes a crank 33 having a first end 331 integrally connected with the swinging member 20 and a link 34 having a first end 341 pivotally connected with a second end 332 of the crank 33. The link 34 has a second end 342 pivotally connected with one face of the driven gear 32. The link 34 has a length shorter than a length of the crank 33. Accordingly, when the air-conditioner is activated and wind blows, the driving gear 31 is rotated along with the fan 12. At this time, the driven gear 32 is driven and rotated. Also, via the link 34 and the crank 33, the swinging member 20 connected with the crank 33 is swung back and forth within a certain range of angle.

According to the above arrangement, the swinging decoration of the present invention has the following advantages:

1. The decorative plates 24 of the swinging decoration of the present invention can simulate the wings of an insect or the body of an animal. The decorative plates 24 are tightly replaceably sandwiched between the fixing plats 22 and the pressboards 23. By means of replacing the decorative plates 24, the configuration of the simulated insect can be changed as necessary. Therefore, it is no more necessary to manufacture various molds so that the cost can be reduced.

2. The decoration main body 14 simulating the insect or the animal has the I-shaped insertion tenon 141 and the insertion slots 142 for latching with the chucking seat 116. The I-shaped insertion tenon 141 and the insertion slots 142 are able to resist against multidirectional external force so as to prevent the decoration main body 14 from dropping down from the chucking seat 116.

3. The connecting seat 15 can be universally adjusted relative to the resilient clip 16. Therefore, the fan 12 can be such as adjusted to be right aligned with the wind exit, whereby the wind can easily drive the fan 12.

4. In the driving mechanism 30, the length of the crank 33 is longer than the length of the link 34, whereby the swinging member 20 can be easily driven.

5. The bottom of the chamber 114 in which the aromatic 13 is placed is formed with multiple vents 115 communicating with the wind-guiding passage 111. In addition, the opening of the chamber 114 is formed with a wind-guiding slope 114a. The aromatic particles can be blown to remote place and spread around.

The above embodiments are only used to illustrate the present invention, not intended to limit the scope thereof. Many modifications of the above embodiments can be made without departing from the spirit of the present invention.

What is claimed is:

1. A swinging decoration of wind exit, comprising:
(a) a fan unit including a housing formed with an axial wind-guiding passage, a fan being pivotally mounted in the wind-guiding passage;
(b) a swinging member pivotally connected to an outer circumference of the housing; and
(c) a driving mechanism installed between a rotary shaft of the fan and the swinging member and drivable by the fan to drive the swinging member to reciprocally swing up and down, the swinging member having a projecting fixing plate formed with fixing pins, whereby the fixing pins can be inserted in corresponding pinholes of a pressboard, a decorative plate being tightly clamped and sandwiched between the fixing plate and the pressboard.

2. The swinging decoration of the wind exit as claimed in claim 1, wherein a chamber is formed on an outgoing side of the housing, a bottom of the chamber being formed with multiple vents axially communicating with the wind-guiding passage in alignment with the fan.

3. The swinging decoration of the wind exit as claimed in claim 1, wherein a chamber is formed on an outgoing side of the housing, an opening of the chamber being formed with a wind-guiding slope.

4. The swinging decoration of the wind exit as claimed in claim 1, wherein a chucking seat is arranged on an outer circumference of the housing of the fan unit, a decoration main body being chucked on the chucking seat, a bottom of the decoration main body having an I-shaped insertion tenon, while the chucking seat having a corresponding mortise in which the tenon can be inserted, the tenon being held by two opposite walls of the mortise to prevent the decoration main body from transversely and longitudinally sliding.

5. The swinging decoration of the wind exit as claimed in claim 4, wherein a bottom of the decoration main body is formed with multiple insertion slots, the chucking seat further having insertion slats corresponding to the insertion slots, whereby the insertion slats can be inserted in the insertion slots to firmly locate the decoration main body on the chucking seat.

6. The swinging decoration of the wind exit as claimed in claim 1, further comprising a connecting seat having an insertion bolt at one end for latching with an incoming side of the housing, a resilient clip being connected with the other end of the connecting seat, the resilient clip having a pair of resilient clip arms extending from a first side of the resilient clip, a second side of the resilient clip having a ball joint pivotally fitted in a ball cavity of the connecting seat, whereby the connecting seat can be universally adjusted to vary the angular position of the fan unit.

7. The swinging decoration of the wind exit as claimed in claim 1, wherein the swinging decoration comprises a pair of swinging members each having a gear pivotally disposed on the housing of the fan unit, the gears of the swinging members being engaged with each other, one of the gears being drivable by the driving mechanism.

8. The swinging decoration of the wind exit as claimed in claim 1, wherein the decorative plate is formed with through holes through which the fixing pins of the fixing plate are fitted to prevent the decorative plate from dropping when the swinging member swings.

9. The swinging decoration of the wind exit as claimed in claim 1, wherein the driving mechanism includes a driving gear coupled with the rotary shaft of the fan and a driven gear pivotally connected with the fan unit and always drivingly engaged with the driving gear, the driven gear being arranged in the wind-guiding passage and aligned therewith, the driven gear being formed with multiple vents, the driving mechanism further including a crank having a first end integrally connected with the swinging member and a link having a first end pivotally connected with a second end of the crank, the link having a second end pivotally connected with one face of the driven gear, the link having a length shorter than a length of the crank.

10. A swinging decoration of wind exit, comprising:
(a) a fan unit including a housing formed with an axial wind-guiding passage, a fan being pivotally mounted in the wind-guiding passage;
(b) a swinging member pivotally connected to an outer circumference of the housing; and
(c) a driving mechanism including a driving gear coupled with the rotary shaft of the fan and a driven gear pivotally connected with the fan unit and always drivingly engaged with the driving gear, the driven gear being arranged in the wind-guiding passage and aligned therewith, the driven gear being formed with multiple vents, the driving mechanism further including a crank having a first end connected with the swinging member and a link having a first end pivotally connected with a second end of the crank, the link having a second end pivotally connected with one face of the driven gear, the link having a length shorter than a length of the crank.
